(19) United States
(12) Patent Application Publication
(10) Pub. No.: US 2024/0142722 A1
(43) Pub. Date: May 2, 2024

(54) ELASTIC AVERAGING COUPLING

(71) Applicant: Senko Advanced Components, Inc., Hudson, MA (US)

(72) Inventors: Yang CHEN, Thousand Oaks, CA (US); Robert Ryan VALLANCE, Newbury Park, CA (US)

(21) Appl. No.: 18/496,841

(22) Filed: Oct. 28, 2023

Related U.S. Application Data
(63) Continuation-in-part of application No. 18/467,449, filed on Sep. 14, 2023.
(60) Provisional application No. 63/420,042, filed on Oct. 27, 2022.
(60) Provisional application No. 63/512,011, filed on Jul. 5, 2023.
(60) Provisional application No. 63/492,704, filed on Mar. 28, 2023.
(60) Provisional application No. 63/512,600, filed on Jul. 7, 2023.

(51) Int. Cl. G02B 6/38

(52) U.S. Cl. CPC G02B 6/3885

(57) ABSTRACT

A passive optical alignment coupling between two bodies each having a complementary interstitial two-dimensional planar array of protrusions defining an array of interstices. Each array of protrusions defines an array of discrete protrusions separated and isolated from one another on the surface of the corresponding bodies. When the bodies are pressed together, the array of protrusions defined on one body intermesh with protrusions defined on the other body with protrusions of one body received in corresponding interstices defined on the other body. The protrusion surfaces of each adjacent pair of protrusions are in point contact. The first body is removably attachable to the second body to define a demountable coupling, with the first array of alignment features against the second array of alignment features to define an elastic averaging coupling, thereby passively aligning the first body to the second body.

### PRIORITY CLAIM

This application claims the priorities of (a) U.S. Provisional Patent Application No. 63/420,042 filed on Oct. 27, 2022; (b) U.S. Provisional Patent Application No. 63/492,704 filed on Mar. 28, 2023; (c) U.S. Provisional Patent Application No. 63/512,011 filed on Jul. 5, 2023; (d) U.S. Provisional Patent Application No. 63/512,600 filed on Jul. 7, 2023; and (e) U.S. Utility patent application Ser. No. 18/467,449 filed on Sep. 14, 2023. These applications are fully incorporated by reference as if fully set forth herein. All publications noted below are fully incorporated by reference as if fully set forth herein.

### BACKGROUND OF THE INVENTION

### 1. Field of the Invention

The present invention relates to coupling of light into and out of optoelectronic components (e.g., photonic integrated circuits (PICs)), and more particular to the optical connection of optical fibers to PICs.

### 2. Description of Related Art

Photonic integrated circuits (PICs) or integrated optical circuits are part of an emerging technology that uses light as a means of communication, computing, or sensing as opposed to an electric current. A PIC integrates multiple (at least two) photonic functions and as such is analogous to an electronic integrated circuit. The major difference between the two is that a photonic integrated circuit provides functionality for information signals on optical wavelengths typically in the visible spectrum or near infrared 850 nm-1650 nm.

PICs are used for various applications in telecommunications, instrumentation, sensing, and signal-processing fields. A PIC may be made using various material platform such as silicon (Si), silicon nitride (SiN), indium phosphide (InP). The PIC, regardless of material, typically uses optical waveguides to route optical signals throughout the PIC and/or to interconnect various elements, such as optical switches, couplers, routers, splitters, multiplexers/demultiplexers, modulators, amplifiers, wavelength converters, optical-to-electrical (O/E) (e.g. photodiodes) and electrical-to-optical (E/O) converters (e.g. lasers), etc. A waveguide in a PIC device is usually an on-PIC solid light conductor that guides light due to an index-of-refraction difference between the waveguide's core material and cladding material.

For proper operation, a PIC often needs to efficiently couple light signals between an external optical fiber and one or more of on-chip waveguides. An advantage of using light as a basis of circuit operation in a PIC is that its energy cost for high-speed signal transmission is substantially less than that of electronic chips, thus efficient signal transmission between PIC devices and other optical devices, such as optical fibers, that maintains this advantage is an important aspect of PICs.

Most PICs require single-mode optical connections that require stringent alignment tolerances between optical fibers and the PIC, typically less than 1 micrometer. Efficient optical coupling to and from the on-chip waveguides to an external optical fiber is challenging due to the mismatch in size between the single-mode waveguides and the light-guiding cores within single-mode optical fibers. For example, the dimension of a typical silica optical fiber is approximately forty times larger than a typical waveguide on a PIC. Because of this size mismatch, if the single mode waveguide and the optical fiber are directly coupled, the respective modes of the waveguide and optical fiber will not couple efficiently resulting in an unacceptable insertion loss (e.g., >10 dB).

One approach to coupling optical fibers to a PIC device (or a PIC chip package) is to attach an optical fiber array to the edge of the PIC chip. Heretofore, optical fiber arrays are aligned to elements on the PICs using an active alignment approach in which the position and orientation of the optical fiber(s) is adjusted by machinery until the amount of light transferred between the fiber and PIC is maximized. This is a time-consuming process that is generally done after the PIC is diced from the wafer and mounted within a package. This postpones the fiber-optic connection to the end of the production process. Once the connection is made, it is permanent, and would not be demountable, separable or detachable without likely destroying the integrity of connection for any hope of remounting the optical fiber array to the PIC. In other words, the optical fiber array is not removably attached to the PIC, and the fiber array connection, and separation would be destructive and not reversible (i.e., not reconnectable).

One of the most expensive components within photonic networks is the fiber-optic connectors. The current state-of-the-art attempts to achieve stringent alignment tolerances using polymer connector components, but polymers have several fundamental disadvantages. First, they are elastically compliant so that they deform easily under external applied loads. Second, they are not dimensionally stable and can change size and shape especially when subjected to elevated temperatures such as those found in computing and networking hardware. Third, the coefficient of thermal expansion (CTE) of polymers is much larger than the CTE of materials that are commonly used in PIC devices. Therefore, temperature cycles cause misalignment and mechanical stress between the optical fibers and the optical elements on the PIC devices. In some cases, like wave soldering, the polymers cannot withstand the processing temperatures used while soldering PIC devices onto printed circuit boards. Furthermore, the inherent component costs quickly escalate as the required accuracy of the component increases. That is, the cost of a connector increases as the positional and alignment tolerances become more demanding.

In addition, it would be advantageous if the fiber-optic connections could be created prior to dicing the discrete PICs from the wafer; this is often referred to as wafer-level attachment. Manufacturers of integrated circuits and PICs often have expensive capital equipment capable of sub-micron alignment (e.g., wafer probers and handlers for testing integrated circuits), whereas companies that package chips generally have less capable machinery (typically several micron alignment tolerances which is not adequate for single-mode devices). However, it is impractical to permanently attach optical fibers to PICs prior to dicing since the optical fibers would become tangled, would be in the way during the dicing operations and packaging procedures, and are practically impossible to manage when the PICs are pick-and-placed onto printed circuit boards and then soldered to the PCBs at high temperatures.

US Patent Publication No. 2016/0161686A1 (commonly assigned to the assignee of the present application, and fully incorporated by reference herein) discloses demountable optical connectors for optoelectronic devices. The disclosed demountable optical connectors include implementation of an elastic averaging coupling to provide an improved approach to optically couple input/output of optical fibers to PICs which improves tolerance, manufacturability, ease of use, functionality and reliability at reduced costs. As is known in the prior art, elastic averaging represents a subset of surface coupling types where improved accuracy is derived from the averaging of errors over a large number of contacting surfaces. Contrary to kinematic design, elastic averaging is based on significantly over-constraining the solid bodies with a large number of relatively compliant members. As the system is preloaded, the elastic properties of the material allow for the size and position error of each individual contact feature to be averaged out over the sum of contact features throughout the solid body. Although the repeatability and accuracy obtained through elastic averaging may not be as high as in deterministic kinematically coupled systems, elastic averaging design allows for higher stiffness and lower local stress when compared to kinematic couplings. In a well-designed and preloaded elastic averaging coupling, the repeatability is approximately inversely proportional to the square root of the number of contact points.

U.S. Pat. No. 11,500,166 (commonly assigned to the assignee of the present application, and fully incorporated by reference herein) further discloses a passive optical alignment coupling between an optical connector having a first two-dimensional planar array of alignment features and a foundation having a second two-dimensional planar array of alignment features. One of the arrays is a network of orthogonally intersecting longitudinal grooves defining an array of discrete protrusions that are each in a generally pyramidal shape with a truncated top separated from one another by the orthogonally intersecting longitudinal grooves, and the other array is a network of longitudinal cylindrical protrusions. The cylindrical protrusions are received in the grooves, with protrusion surfaces of the cylindrical protrusions in line contact with groove surfaces and the top of the discrete protrusions contacting the surface bound by the cylindrical protrusion. The optical connector is removably attachable to the foundation to define a demountable coupling, with the first array of alignment features against the second array of alignment features to define an elastic averaging coupling.

What is needed is an improved demountable passive alignment coupling, in particular a demountable passive optical alignment coupling based on an improved elastic averaging approach that further improves tolerance, manufacturability, ease of use, functionality and reliability at reduced costs.

### SUMMARY OF THE INVENTION

The present invention further improves on the prior art by providing a demountable/separable and reconnectable passive alignment coupling/connection that achieves high alignment accuracy and repeatability. In connection with optical coupling, an optical connector (e.g., supporting or as a part of an optical bench that supports an optical fiber) is configured and structured to be non-destructively, removably attachable for reconnection to the foundation in alignment therewith. The foundation may be an integral part of the opto-electronic device (e.g., part of a photonic integrated circuit (PIC)), a separate component attached to the opto-electronic device, or positioned in optical alignment with the opto-electronic device, e.g., on a printed circuit board (PCB). Alternatively, the foundation may be an integral part of or attached to another optical connector.

The present invention will be explained in connection with the illustrated embodiments. The foundation can be aligned to electro-optical elements (e.g., grating couplers, spot-converters, edge-emitting waveguides, etc.) in the optoelectronic device. The foundation is permanently positioned with respect to the opto-electronic device to provide an alignment reference to the external optical connector. The optical connector can be removably attached to the foundation, via a ‘separable’ or ‘demountable’ or ‘detachable’ action that accurately optically aligns the optical components/elements in the optical bench to the opto-electronic device along a desired optical path. To maintain optical alignment for each connect and disconnect and reconnect, this connector needs to be precisely and accurately aligned passively to the foundation. In accordance with the present invention, the connector and foundation are aligned with one another using a passive mechanical alignment, specifically, elastic averaging alignment, constructed from geometric features on the two bodies. With the foregoing as introduction, the present invention may be summarized below.

In one aspect, the inventive passive alignment coupling comprises: a first body defining a first base having a first, planar, surface (i.e., a first mating or interfacing surface) on which a first array of alignment features is defined; and a second body providing an alignment reference to the first body, wherein the second body defines a second base having a second, planar, surface (i.e., a second mating or interfacing surface) on which a second array of alignment features is defined. The first and second array of alignment features are complementary to each other, wherein one of the first array of alignment features and the second array of alignment features comprises a first interstitial two-dimensional planar array of protrusions (or bumps) defining a first array of interstices, and another one of the first array of alignment features and the second array of alignment features comprises a second interstitial two-dimensional planar array of protrusions defining a second array of interstices. When the first body is pressed against the second body with the first and second arrays of alignment features mating towards each other, the first and second arrays of protrusions intermesh with the protrusions defined on one of the first and second bodies received in corresponding interstices defined on the other one of the first and second bodies, wherein protrusion surfaces of each adjacent pair of protrusions are in point contact. Accordingly, the first body is removably attachable to the second body to define a demountable coupling, with the first array of alignment features against the second array of alignment features to define an elastic averaging coupling, thereby passively aligning the first body to the second body.

In one embodiment, each of the first and second arrays of protrusions defines an array of discrete protrusions separated and isolated from one another on the respective first and second surfaces. In one embodiment, each protrusion of the first and second arrays of protrusions comprises a side wall about an axis orthogonal to the corresponding first and second surfaces, wherein at least at the point contact between the protrusion surfaces of adjacent pair of protrusions, the side wall has a convex radius of curvature with respect to the axis and has a convex slope along the side wall in an axial plane including the axis (orthogonal to the corresponding first and second surfaces). In one embodiment, the side wall of each protrusion is axially symmetrical about the axis and has a draft slope at a draft angle to the axis, wherein the side wall defines a single point of contact between the protrusion surfaces of each adjacent pair of protrusions.

In a specific embodiment, the side wall of each protrusion is shaped to follow or conform to a surface of a body generated by rotating a non-uniform rational b-spline (NURBS) curve about the axis, and wherein the contact point is located at the symmetry line for the NURBS curves of each adjacent pair of protrusions, whereby tangency is present at the point contact to define the single point of contact between the protrusion surfaces of each adjacent pair of protrusions.

In one embodiment, each protrusion of the second array of protrusions is taller than each protrusion of the first array of protrusion, wherein each protrusion of the second array of protrusions has a convex apex, wherein with the first body pressed against the second body with the first and second arrays of alignment features towards each other, the apex of each of the taller protrusions of the second array of protrusions contacts the first planar surface of the first body at the interstices (i.e., bottom or base plane of the interstices) defined by the first array of protrusions at a point contact, wherein a gap remains between the top of each protrusion of the first array of protrusions and the second planar surface at the interstices defined by the second array of protrusions.

In another embodiment, the side wall of each protrusion of the first and second array of protrusions is axially symmetric about the axis and has the convex slope in the axial plane. The convex protrusion surfaces of each adjacent pair of protrusions are in point contact. In a specific embodiment, the side wall of each protrusion is shaped substantially to conform to a hemisphere, a truncated portion of a hemisphere (e.g. with a truncated top and/or bottom), or a more complex axi-symmetric shape defined by revolving a NURBs curve about the axis. In one embodiment, each protrusion has an apex that contacts the corresponding one of the first and second planar surfaces at a point contact or small finite area when the first body is pressed against the second body with the first and second arrays of alignment features towards each other.

In one embodiment, each of the first and second arrays of protrusions includes at least 5 to 100 discrete protrusions for a coupling interface between the first body and the second body having a planar area of about 10 mm² to 100 mm², so as to achieve a coupling accuracy of less than 1 micrometer between the first body and the second body. In a further embodiment, each of the first and second arrays of protrusions is a rectangular staggered array of M×N discrete protrusions. In one embodiment, M is preferably in a range of 3 to 10 and N is in a range of 3 to 10 for a coupling interface between the first body and the second body having a planar area of about 5 mm² to 50 mm², so as to achieve a coupling accuracy of less than 1 micrometer between the first body and the second body.

In one embodiment, the first and second arrays of protrusion are integrally formed on the corresponding first and second bodies (e.g., by etching or stamping a metal, etching silicon, or molding glass), or are formed in a separate layer (e.g., etching or stamping a sheet of metal, etching silicon, or molding glass) and attached to the corresponding first and second bodies. The separate layer of array of protrusions may be further formed with an opening at the apex of each protrusion, and may be further formed with slits along the side wall of each protrusion, thereby providing a more flexible, pliant or compliant structure.

In one embodiment, the first and second arrays of protrusions comprise protrusions spatially distributed on the respective first and second surfaces in a symmetrical pattern about at least an axis on the respective first and second surfaces. In a further or alternate embodiment, the first and second arrays of protrusions comprise protrusions spatially distributed on the respective first and second surfaces in a similar pattern.

In one embodiment, the first base comprises a first malleable metal material and the first array of alignment features of the optical connector are integrally defined on the first base by stamping the malleable metal material, and the second base comprises a second malleable material and the second array of alignment features are integrally defined on the base by stamping the second malleable metal material.

In one embodiment, the optical connector further comprises a first micro-mirror optical bench, which comprises the first base; a first array of mirrors defined on the first base, wherein each mirror includes a structured reflective surface profile that turns light between a first light path, along a first direction in a first plane substantially parallel to the first surface of the first base, and a second light path, along a second direction outside the first plane; and an array of fiber grooves defined on the first base each receiving a section of optical fiber with its longitudinal axis along the first light path, with an end in optical alignment with a corresponding mirror along the first light path. In one embodiment, the foundation comprises a second micro-mirror optical bench, which comprises: the second base; and a second array of mirrors defined on the second base, wherein each mirror in the second array of mirrors includes a structured reflective surface profile that turns light between a third light path, along a third direction in a second plane substantially parallel to the second surface of the second base, and a fourth light path, along a fourth direction outside the second plane.

In one embodiment, the first array of mirrors and the first array of alignment features are simultaneously defined on the first base by stamping a first body of metal blank and the second array of mirrors and the second array of alignment features are simultaneously defined on the second base by stamping a second body of metal blank. By high-precision stamping to integrally/simultaneously form the passive alignment features and/or the micro optical bench (MOB) on the foundation and the optical connector, the components can be produced economically in high or small volumes, while improving tolerance, manufacturability, ease of use, functionality and reliability. The foundation and/or optical bench components should be made of stampable materials like ductile metals such as Kovar, Invar, stainless steel, aluminum. Preferably, the optical bench and foundation should both have similar coefficients of thermal expansion (CTEs) that are nearly equal to the PIC, so that misalignment does not occur during temperature cycles and stress/strains are not generated.

In one embodiment, at least one of the first body and the second body comprises at least one optical waveguide, such as an optical fiber.

In one embodiment, the first base of the optical connector has a first reference surface at a first side of the first base and the second base of the foundation has a second reference surface at a second side of the second base. The first reference surface and the second reference surface are generally aligned by a compliant clip biasing the first base against the second base with the first array of alignment features against the second array of alignment features.

In one embodiment, the optical connector and the foundation define a free-space coupling without any refractive optical elements disposed between the optical connector and the foundation to provide reshaping of light.

The demountable elastic averaging coupling between the optical connector and the foundation is defined without use of any complementary alignment pin and alignment hole. The inventive elastic averaging coupling of the present invention may be deployed in a photonic apparatus. In one embodiment, the photonic apparatus comprises a support; an optoelectronic device attached to a top surface of the support; and a passive optical alignment comprising the inventive elastic averaging passive alignment coupling. The foundation comprising the second body of the passive alignment coupling may be positioned relative to the optoelectronic device (e.g., as an integral part of or on the optoelectronic device and/or the support (e.g., a PCB)), to define an aligned position for the optoelectronic device to communicate optical signals with the optical connector removably/demountably coupled to the foundation. The optoelectronic device may comprise a photonic integrated circuit (PIC) chip comprising optical elements as an optical interface to external of the PIC chip. The foundation is in optical alignment with the optical elements of PIC chip.

In one embodiment, the foundation comprises an edge coupler supported on the support in optical alignment with respect to the PIC chip. The optical waveguides of the PIC chip route light to an edge of the PIC chip, with or without a spot converter that expands the modefield of the light to more closely match that of an optical fiber. The edge coupler may comprise an array of mirrors in optical alignment with the optical elements of the PIC chip, and light is transmitted along a light path between a mirror in the array of mirrors and a corresponding optical element in the PIC chip.

The present invention is also directed to a method for providing a demountable connection between an optical connector and an optoelectronic device, comprising a support having a top surface on which the optoelectronic device is attached; and providing the inventive passive alignment coupling as discussed herein, wherein the foundation is positioned relative to the optoelectronic device, either as an integral part of or on the optoelectronic device and/or the support, and wherein the foundation defines an aligned position for the optoelectronic device to communicate optical signals with the optical connector that is demountably coupled to the foundation.

In one embodiment, an assembly optical connector is provided as a master optical connector form for assembly of the foundations. The master optical connector form conforms to the passive alignment features and the optical inputs/outputs corresponding to the optical connector that is designed to be mechanically and optically coupled to the external optoelectronic device. The master optical connector form is first demountably coupled to the foundation. The master optical connector form is actively aligned to the optoelectronic device by positioning the foundation relative to the optoelectronic device (e.g., a PIC chip or an optical I/O chip) to obtain an optimum optical signal between the optoelectronic device and the master optical connector (e.g., optical fibers supported by the optical connector). The location of the foundation is secured with respect to the optoelectronic device at the aligned position (e.g., using either epoxy or solder to join the position of the foundation on a support for the optoelectronic device, such as an interposer, a printed circuit board, a submount, etc.). The foundation remains permanently attached to the support (e.g., curing the epoxy or reflowing the solder) without changing its position on the support. Then, the master optical connector form is demounted from the foundation. Thereafter, the designed optical connector can be repeatedly connected and disconnected and reconnected to the foundation non-destructively without losing the original optical alignment obtained by active alignment between the optical connector and the optoelectronic device. Optical alignment in accordance with original active alignment is maintained for each connect and disconnect and reconnect, to precisely and accurately align the optical connector to the foundation.

In one embodiment, the foundation may be an integral part of the optoelectronic device or the support for the optoelectronic device.

### BRIEF DESCRIPTION OF THE DRAWINGS

For a fuller understanding of the nature and advantages of the invention, as well as the preferred mode of use, reference should be made to the following detailed description read in conjunction with the accompanying drawings. In the following drawings, like reference numerals designate like or similar parts throughout the drawings.

FIG. 1A illustrates an optical connector and a foundation that can be implemented with the inventive elastic averaging features disclosed hereinbelow for demountable coupling, FIGS. 1B to 1D illustrate positioning of a foundation as an edge coupler to a PIC chip, and 1E and 1F illustrate connection of an optical connector to the foundation, which can be adopted in accordance with one embodiment of the present invention.

FIGS. 2A to 2E illustrate elastic averaging coupling interface of an optical connector to a foundation, in accordance with one embodiment of the present invention.

FIGS. 3A and 3B illustrate passive alignment features of an optical connector and a foundation in the form of another optical connector, in accordance with another embodiment of the present invention.

FIG. 4A schematically illustrates complementary elastic averaging features at opposing mating surfaces at the optical connector side and the foundation side, in accordance with one embodiment of the present invention; FIG. 4B illustrates perspective view of demountable coupling between the connector and the foundation in FIG. 4A; and FIG. 4C schematically illustrates the contact points between complementary arrays of elastic averaging features, in accordance with one embodiment of the present invention.

FIG. 5A is a schematic perspective view illustrating contacts between complementary bumps in the complementary arrays of elastic averaging features, in accordance with one embodiment of the present invention; and FIG. 5B is a schematic graphical view illustrating contacts between complementary bumps in the complementary arrays of elastic averaging features, in accordance with one embodiment of the present invention.

FIG. 6A illustrates perspective side view of the demountable coupling between the connector and the foundation in FIG. 4A; and FIG. 6B is a schematic graphical view illustrating the planar distribution of the protrusions and the contact points between complementary arrays of protrusions with exemplary relative dimensions in accordance with one embodiment of the present invention.

FIG. 7A illustrates perspective side view of the demountable coupling between the connector and the foundation in accordance with another embodiment of the present invention; and FIG. 7B is a schematic graphical view illustrating the planar distribution of the protrusions and the contact points between complementary arrays of protrusions with exemplary relative dimensions, in accordance with one embodiment of the present invention.

FIG. 8A illustrates perspective side view of the demountable coupling between the connector and the foundation in accordance with a further embodiment of the present invention; and FIG. 8B is a schematic graphical view illustrating the planar distribution of the protrusions and the contact points between complementary arrays of protrusions with exemplary relative dimensions, in accordance with one embodiment of the present invention.

FIG. 9A illustrates perspective side view of the demountable coupling between the connector and the foundation in accordance with a still further embodiment of the present invention; and FIG. 9B is a schematic graphical view illustrating the planar distribution of the protrusions and the contact points between complementary arrays of protrusions with exemplary relative dimensions, in accordance with one embodiment of the present invention.

FIG. 10A to 10C illustrate further embodiments of protrusion arrays of elastic averaging coupling interfaces.

FIGS. 11A to 11C illustrate implementation of a transparent foundation with an integral internally reflective surface as an edge coupler to a PIC chip package, and demountable coupling of an optical connector to the PIC chip package via a transparent cover plate having an array of protrusions for elastic averaging alignment, in accordance with one embodiment of the present invention.

FIG. 12A is a sectional view of a demountable coupling of an optical connector directly to a PIC chip package, in accordance with one embodiment of the present invention; and FIG. 12B is a sectional view of a demountable coupling of an optical connector to a PIC chip package via an interposer, in accordance with one embodiment of the present invention.

FIGS. 13A to 13C illustrate a process of securing position of the foundations for subsequent demountable connection of optical connectors, in accordance with one embodiment of the present invention; and FIG. 13D is a schematic perspective view of an optical connector at one end of an optical fiber jumper, in accordance with one embodiment of the present invention.

FIG. 14A schematically illustrates the grating couplers and waveguide on a PIC device for loop-back active alignment of a master optical connector form to the PIC device, in accordance with one embodiment of the present invention; FIGS. 14B and 14C illustrate a master optical connector form and initial demountable coupling of a foundation prior to active alignment in FIG. 13A; in accordance with one embodiment of the present invention.

### DETAILED DESCRIPTION OF THE PREFERRED EMBODIMENTS

This invention is described below in reference to various embodiments with reference to the figures. While this invention is described in terms of the best mode for achieving this invention's objectives, it will be appreciated by those skilled in the art that variations may be accomplished in view of these teachings without deviating from the spirit or scope of the invention.

The present invention overcomes the drawbacks of the prior art by providing a demountable/separable and reconnectable passive alignment coupling/connection of two bodies, which achieves high alignment accuracy and repeatability.

The present invention will be discussed in detail below by reference to the example of optical coupling, in which an optical connector (e.g., supporting or is a part of an optical bench that supports an optical fiber) is configured and structured to be non-destructively, removably attachable for reconnection to the foundation in alignment therewith. The foundation may be an integral part of the opto-electronic device (e.g., part of a photonic integrated circuit (PIC) chip), a separate component attached to the opto-electronic device or positioned in optical alignment with the opto-electronic device, e.g., on a printed circuit board (PCB). Alternatively, the foundation may be an integral part of or attached to another optical connector.

The elastic averaging coupling concept of the present invention is discussed hereinbelow by reference to the example of a PIC as an optoelectronic device and an optical connector comprising an optical bench, and optically coupling an input/output end of an optical component (e.g., an optical fiber) supported in the optical bench with the optoelectronic device. The present invention may be applied to provide removable/reconnectable form structures and parts used in other fields.

As a background for optical coupling, general reference is made to U.S. Pat. No. 11,500,166 (commonly assigned to the assignee of the present application, and fully incorporated by reference herein), which discloses a passive alignment demountable coupling of an optical connector and a foundation having complementary elastic averaging features. The present invention discloses inventive elastic averaging features that can be implemented to replace the elastic averaging features disclosed in that patent for demountable coupling of an optical connector to a foundation.

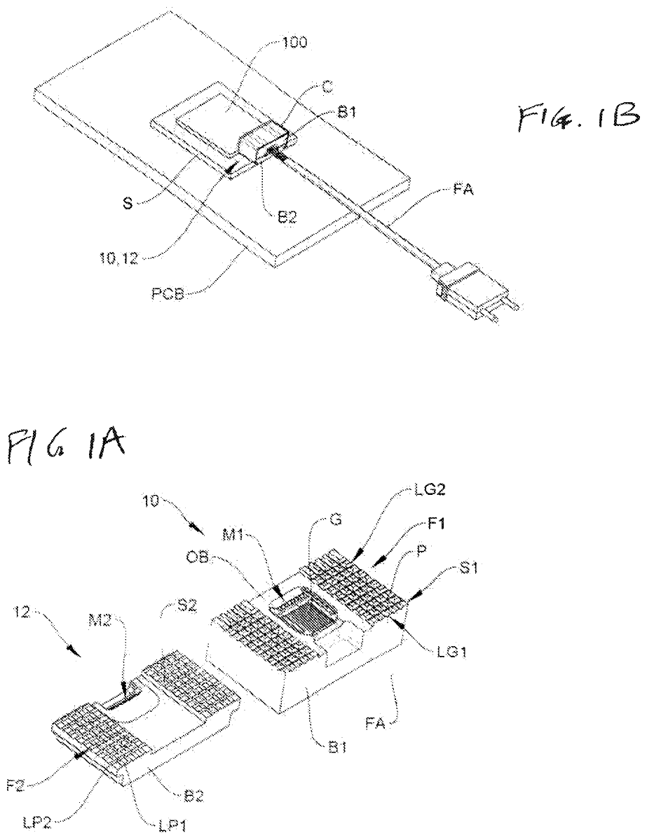

FIG. 1A illustrates an optical connector and a foundation that can be implemented with the inventive elastic averaging features in accordance with the present invention disclosed hereinbelow for demountable coupling. The optical connector 10 comprises a first body B1 supporting an optical fiber array (schematically shown by dotted line FA) transmitting an optical signal. The foundation 12 comprises a second body B2 providing an alignment reference to an external optoelectronic device (e.g., a PIC chip 100 in FIG. 1) communicating optical signals with optical fiber OF in the optical connector 10.

The first body of the connector 10 defines a first base B1 supporting the optical fiber array FA having a first, planar, surface S1 defined with a first two-dimensional planar array of alignment features F1 integrally defined on the first surface S1 of the first base B1. In this embodiment, connector 10 incorporates a micro-optical bench OB for supporting and aligning the optical fiber array FA. The optical fiber array FA has a plurality of optical fibers OF protected by protective buffer and matrix/jacket layers P. The base B1 of the connector 10 defines structured features including an alignment structure comprising open grooves G for retaining bare sections of optical fibers OF (having cladding exposed, without protective buffer and matrix/jacket layers), and structured reflective surfaces (e.g., eight mirrors M1) having a plane inclined at an angle relative to the greater plane of the base B1. The open grooves G are sized to receive and located to precisely position the end section of the optical fibers OF in alignment with respect to a first array of mirrors M along a first optical path L1. The end face (input/output end) of each of the optical fibers OF is maintained at a pre-defined distance with respect to a corresponding mirror M1. In the embodiment of FIG. 1D, a transparent glass, quartz, or sapphire plate SP1 covers the exposed surfaces on the optical bench OB to protect the mirrors M1. In one embodiment, connector 10 may be filled with index-matching epoxy between the mirror surfaces M1 and the plate cover SP1.

In one embodiment, each mirror M1 is an exposed free surface of the base B1 (i.e., surface exposed to air, or not internal within the body of the base of the optical bench) having an exposed reflective free side facing away from the base B1. The exposed reflective free side comprises a structured reflective surface profile at which light is directed to and from the optical fiber OF and to and from the foundation 12. Each mirror M1 bends, reflects and/or reshapes an incident light. Depending on the geometry and shape (e.g., curvature) of the structured reflective surface profile, the mirrors M may collimate, expand, or focus an incident light beam. For example, the structured reflective surface profile may comprise one of the following geometrical shape/profiles: (a) ellipsoidal, (b) off-axis parabolic, or (c) other free-form optical surfaces. For example, the mirror surface, to provide optical power, may have a surface geometrical curvature function of any of the following, individually, or in superposition: ellipsoidal or hyperbolic conic foci, toroidal aspheric surfaces with various number of even or odd aspheric terms, X-Y aspheric curves with various number of even or off terms, Zernike polynomials to various order, and various families of surfaces encompassed by these functions. The surfaces may also be free-form surfaces with no symmetry along any plane or vector. The mirrors M may be defined on the base B by stamping a malleable metal material. Various malleable metals, stampable with tool steels or tungsten carbide tools, may compose the body of the mirrors, including any series of stainless steel, any composition of Kovar, any precipitation or solution hardened metal, and any alloy of Ag, Al, Au, Cu. Aluminum is highly reflective across the optical spectrum and economically shaped by stamping. It is most reflective at longer wavelengths above 1310 nm, where aluminum's reflectivity can reach or exceed 98%. The reflective surface of the portion of the metal comprising the mirror may be any of the metals mentioned above, or any coating of highly reflective metal, applied by sputtering, evaporation, or plating process.

U.S. Pat. No. 7,343,770, commonly assigned to the assignee of the present invention, discloses a novel precision stamping system for manufacturing small tolerance parts. Such inventive stamping system can be implemented to produce the structures of the connector 10 and the foundation 12 disclosed herein (including the structures for the optical bench OB discussed above, as well as the structures discussed below). These stamping processes involve stamping a malleable bulk metal material (e.g., a metal blank or stock), to form the final surface features at tight (i.e., small) tolerances, including the reflective surfaces having a desired geometry in precise alignment with the other defined surface features. U.S. Patent Application Publication No. US2016/0016218A1, commonly assigned to the assignee of the present invention, further discloses a composite structure including a base having a main portion and an auxiliary portion of dissimilar metallic materials. The base and the auxiliary portion are shaped by stamping. As the auxiliary portion is stamped, it interlocks with the base, and at the same time forming the desired structured features on the auxiliary portion, such as a structured reflective surface, optical fiber alignment feature, etc. With this approach, relatively less critical structured features can be shaped on the bulk of the base with less effort to maintain a relatively larger tolerance, while the relatively more critical structured features on the auxiliary portion are more precisely shaped with further considerations to define dimensions, geometries and/or finishes at relatively smaller tolerances. The auxiliary portion may include a further composite structure of two dissimilar metallic materials associated with different properties for stamping different structured features. This stamping approach improves on the earlier stamping process in U.S. Pat. No. 7,343,770, in which the bulk material that is subjected to stamping is a homogenous material (e.g., a strip of metal, such as Kovar, aluminum, etc.). The stamping process produces structural features out of the single homogeneous material. Thus, different features would share the properties of the material, which may not be optimized for one or more features. For example, a material that has a property suitable for stamping an alignment feature may not possess a property that is suitable for stamping a reflective surface feature having the best light reflective efficiency to reduce optical signal losses.

The overall functional structures of the optical bench OB generally resemble the structures of some of the optical bench embodiments disclosed in the assignee's earlier patent documents noted above (i.e., fiber alignment grooves aligned with structured reflective surfaces, and addition features to facilitate proper optical alignment). The earlier disclosed composite structure and stamping technology may be adopted to produce the connector 10 including the mirrors M1 in the optical bench OB, the grooves G and the first array of alignment features F1, and further the foundation 12 including the mirrors M2 and the second array of alignment features F2 discussed below. The respective alignment features F1 and F2 are formed on the respective planar surfaces S1 and S2, which facilitates alignment and/or accurate positioning the connector 10 with respect to the foundation 12, and hence with respect to the PIC chip 100/chip 102 or I/O chip 101, as will be explained later below.

The mirror M1 surface and optical fiber alignment structure in the optical connector can be integrally/simultaneous formed by precision stamping of a stock material (e.g., a metal blank or strip), which allows the connector components to be produced economically in high or small volumes, while improving tolerance, manufacturability, ease of use, functionality and reliability. By forming the structure reflective surface, the passive alignment features (discussed below) and the optical fiber alignment structure simultaneously in a same, single final stamping operation, dimensional relationship of all features requiring alignment on the same work piece/part can be maintained in the final stamping step. Instead of a punching operation with a single strike of the punch to form all the features on the optical bench, it is conceivable that multiple strikes may be implemented to progressive pre-form certain features on the optical bench, with a final strike to simultaneously define the final dimensions, geometries and/or finishes of the various structured features on the optical bench, including the mirror, optical fiber alignment structure/groove, passive alignment features discussed below, etc. that are required to ensure (or play significant role in ensuring) proper alignment of the respective components/structures along the design optical path.

Essentially, for the optical connector 10, the base B1 defines an optical bench OB for aligning the optical fibers OF with respect to the mirrors M1. By including the fiber grooves G on the same, single structure that also defines the mirrors M, the alignment of the end sections of the optical fibers OF to the mirrors M1 can be more precisely achieved with relatively smaller tolerances by a single final stamping to simultaneous define the final structure on a single part, as compared to trying to achieve similar alignment based on features defined on separate parts or structures, or based on separate forming steps. By forming the mirrors M1, the optical fiber alignment grooves G simultaneously in a same, single final stamping operation, dimensional relationship of all features/components requiring (or play a role in providing) alignment on the same work piece/part can be maintained in the final stamping step. Further, by the same token, the first array of alignment features F1 can also be formed with the mirrors M1 and the grooves G simultaneously in a same, single final stamping operation to maintain dimensional relationship of all the features (i.e., grooves G, mirrors M1 and alignment features F1) to achieve a desired alignment with a small tolerance.

FIGS. 1B to 1D illustrate positioning of a foundation 12 as an edge coupler to a PIC chip 100, FIGS. 1A, and 1E and 1F illustrate connection of the optical connector 10 to the foundation 12, which can be adopted in accordance with one embodiment of the present invention. As shown, foundation 12 is butted against the PIC chip 100 or positioned with a gap between the edge of the base B2 of the foundation and the facing edge of the PIC chip 100 (as shown in FIG. 1F), with the cover SP2 extending over the PIC chip 100. In this embodiment, foundation 12 is supported on the support S in optical alignment with respect to the PIC chip 100. The optical elements of the PIC chip 100 route light to an edge of the PIC chip 100. Foundation 12 functions as an edge coupler. As explained above, the array of mirrors M2 of the foundation 12 are in optical alignment with the optical elements of the PIC chip 100, and light is transmitted along a light path L3 between a mirror M2 in the mirror array and a corresponding optical element in the PIC chip 100.

In the embodiment shown in FIG. 1D, optical alignment of the mirrors M2 in the foundation 12 and the optical elements in the PIC chip 100 is achieved by passive alignment of the mirror M2 to the edge of the PIC chip based on fiducials V provided on an extended section of cover SP2 beyond the edge of the base B2 of the foundation 12 and fiducials (not shown) provided at a top surface near the edge of the PIC chip 100. The gap can be filled with a material that has an optical index of refraction that is similar to that of the core of the optical fiber and waveguide on the PIC chip 100. The foundation 12 is passively aligned to the PIC chip 100 by optically aligning the fiducials V on the cover SP2 to the fiducials (not shown) provided on the top surface of the PIC chip 100. In another embodiment, foundation 12 may be an integral part of the PIC chip 100 or the support S for the PIC chip 100.

FIGS. 1B, 1E and 1F illustrate the connection of the optical connector 10 to the foundation 12, in accordance with one embodiment of the present invention. The PIC chip 100 is supported on a support S (which may be a submount, interposer), which may be supported on a printer circuit board PCB in FIG. 1B. The first base B1 of the optical connector 10 has a first reference surface R1 at least at one side of the first base B1 and the second base B2 of the foundation 12 has at least a second reference surface R2 at a second side of the second base B2. The first reference surface R1 and the second reference surface R2 are generally aligned by a compliant clip C biasing the first base B1 against the second base B2 with the first array of alignment features F1 seated against the second array of alignment features F2. In FIG. 1B, the optical fiber array FA may be a fiber-optic jumper cable to provide a flexible optical connection for optical signal communication with the PIC chip 100.

FIG. 1F is a sectional view taken along line 1F-1F in FIG. 1E. The mirrors M1 each includes a structured reflective surface profile that turns light (e.g., by 90 degrees) between a first light path L1, along a first direction in a first plane substantially parallel to the first surface S1 of the first base B1 of the connector 10, and a second light path L2, along a second direction outside the first plane. The array of fiber grooves G defined on the first base B1 each supports an end section of optical fiber OF in optical alignment with a corresponding mirror M1 along the first light path L1. The second array of mirrors M2 defined on the second base B2 of the foundation each includes a structured reflective surface profile that turns light between a third light path L3 along a third direction in a second plane substantially parallel to the second surface S2 of the second base B2, and a fourth light path L4 along a fourth direction outside the second plane. The light paths L3 and L4 coincide upon coupling the connector 10 and foundation 12 in the configuration shown, so that a light path is completed between the PIC chip 100 and the optical fibers OF in the fiber array FA.

The structured reflective surface profile of the mirrors M1 and/or mirrors M2 may be configured to reshape the light beam from the PIC chip 100 to produce a mode field that more closely match the mode field of the optical fibers OF in the connector 10. Further, the mirrors M2 in the foundation 12 may be configured with a reflective surface profile to expand or collimate the light beams from the optical elements in the PIC chip 100 and output to the mirrors M1 in the connector 10, and the mirrors M1 in the connector 10 may be configured with a reflective surface profile to focus the light beams from the mirrors M2 in the foundation 12 to focus on the core of the tip/end face of the optical fiber OF held in the grooves G on the base B1 of the optical bench in the connector 10. This expanded beam optical coupling configuration would reduce optical alignment tolerance requirement between the mirrors M2 and the optical fibers OF held in the connector 10.

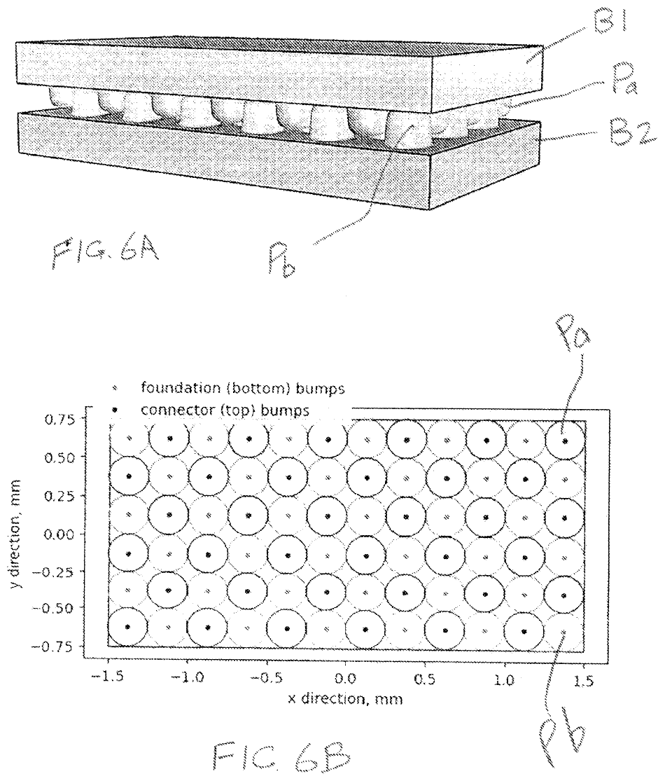

Referring to FIG. 1A, foundation 12 comprises a body having a base B2 (e.g., made of silicon, glass, a malleable metal such as Kovar, Invar, aluminum, stainless steel) with a second array of mirrors M2 defined on the base B2. In the embodiment of FIG. 6B, a transparent glass, quartz, or sapphire plate cover SP2 covers the exposed surfaces on the base B2. In one embodiment, foundation 12 may be filled with index-matching epoxy between the mirror surfaces M2 and the plate cover SP2. The structure of the mirrors M2 on the base B2 of the foundation 12 is quite similar to the corresponding structure of the mirrors M1 on the base B1 of the connector 10. The optical geometries of the respective mirrors M1 and M2 are chosen to implement the desired optical path. In the illustrated embodiment, foundation 12 does not include any optical fiber as compared to connector 10. However, the base B2 may further define grooves receiving short sections of optical fibers (not shown) as waveguides communicating light signals to and from the mirrors B2, as was in the case of the edge couplers disclosed in US Patent Publication No. 2020/0124798A1. The base B2 of foundation 12 has a second, planar, surface S2 defined with a second two-dimensional planar array of alignment features F2 integrally defined on the second surface S2 of the second base B2.

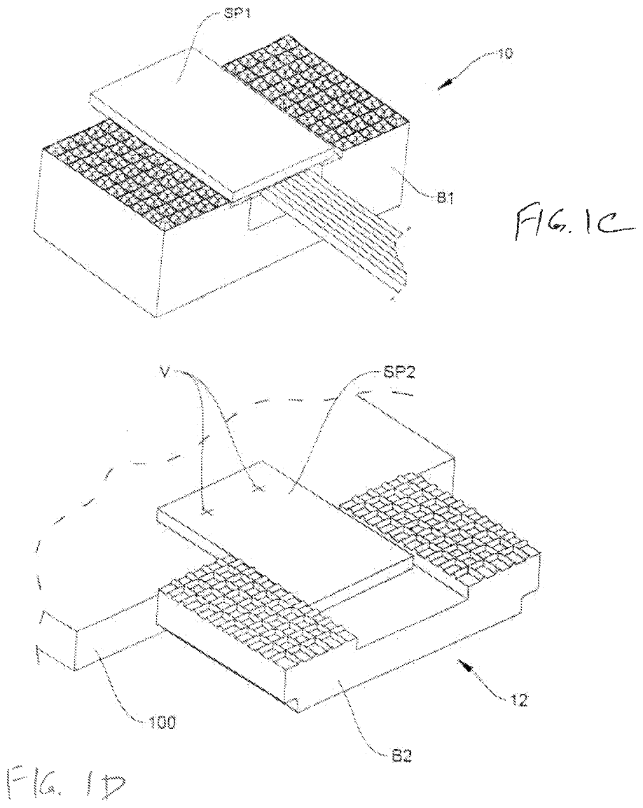

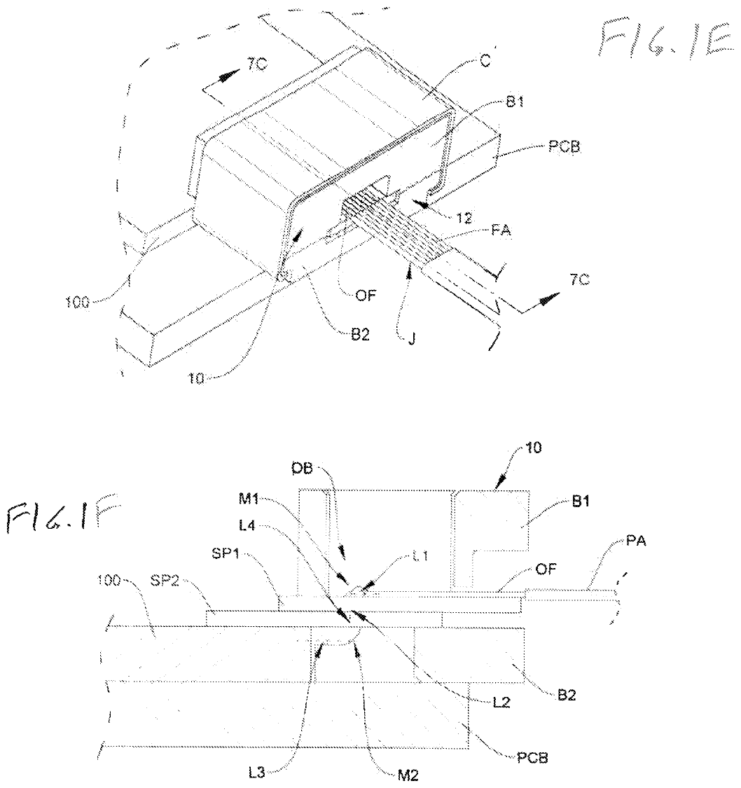

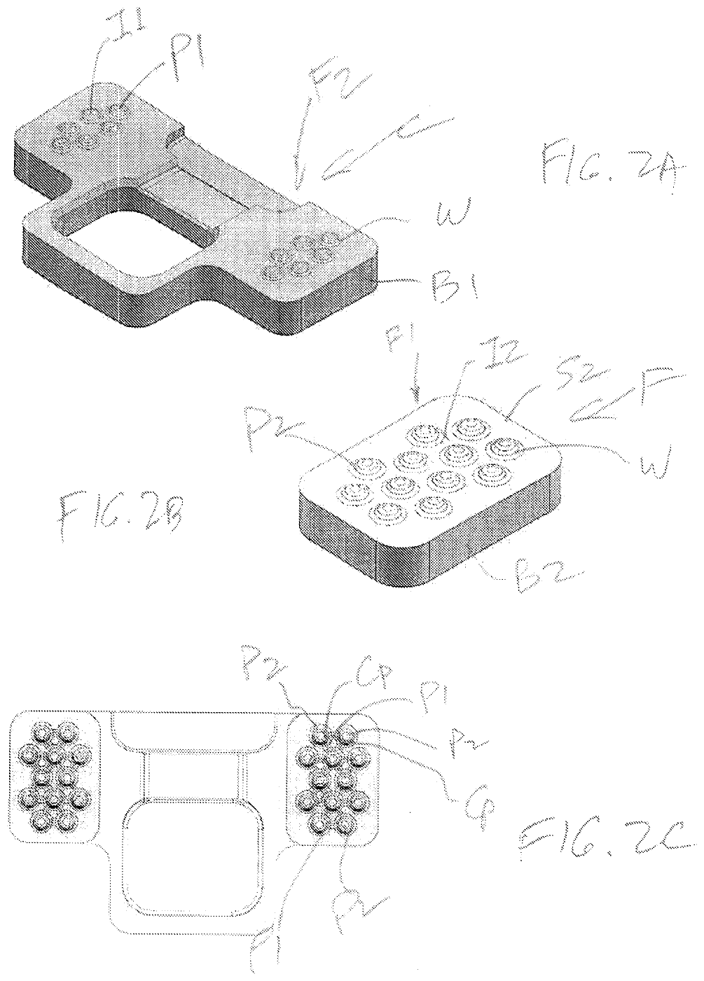

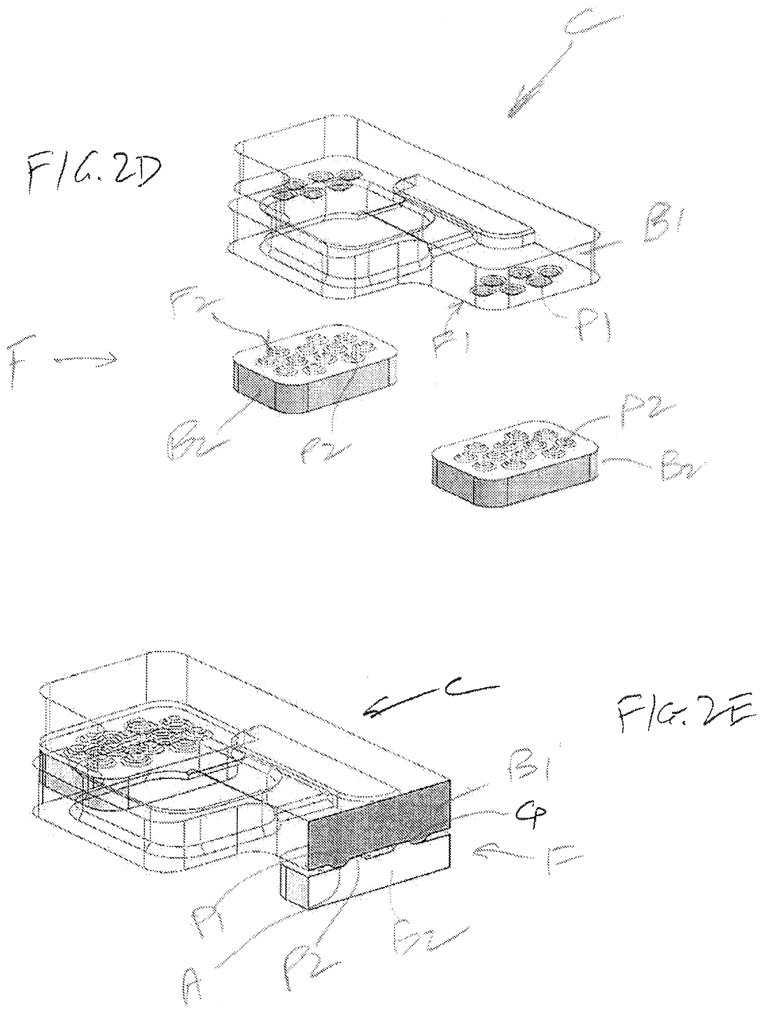

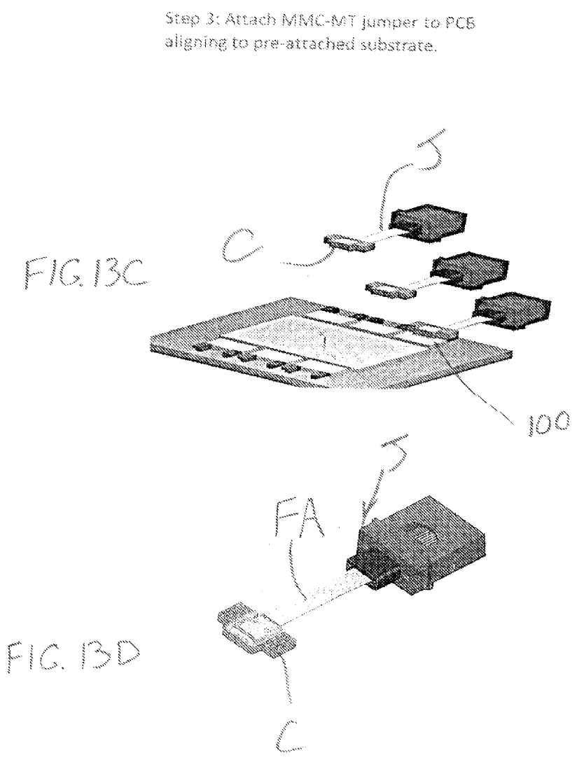

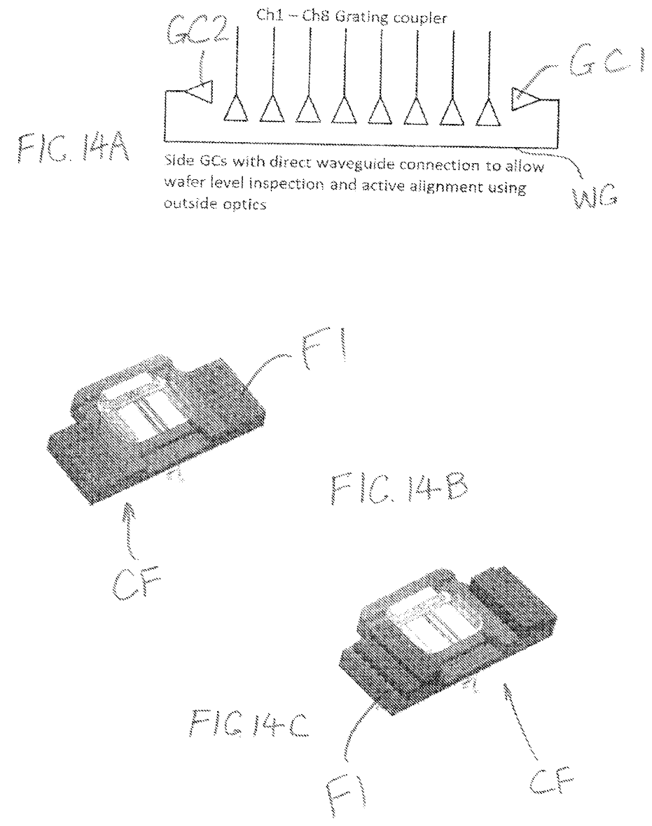

FIGS. 2A to 2E illustrate elastic averaging coupling interface of an optical connector C to a foundation F, having alignment features F1 and F2 comprising elastic averaging features in accordance with one embodiment of the present invention, which can replace the elastic averaging features in the embodiment of FIGS. 1A-1F. The foundation 12 and connector 10 in FIG. 1 can have passive alignment features like the alignment features in FIG. 2 and subsequent embodiments disclosed herein. Connector C can be implemented with a similar optical bench as in connector 10 in the previous embodiment, which may be a connector termination of a fiber array FA for a jumper cable J as illustrated in FIG. 13D, similar to that shown in FIG. 1B.

In the illustrated embodiment in FIGS. 2A and 2B, the inventive passive alignment coupling comprises a first body defining a first base B1 having a first, planar, surface S1 (i.e., a first mating or interfacing surface) on which a first array of alignment features F1 is defined; and a second body providing an alignment reference to the first body, wherein the second body defines a second base B2 (comprising two separate bases in the illustrated embodiment in FIG. 2) having a second, planar, surface (i.e., a second mating or interfacing surface) on which a second array of alignment features F2 is defined. The first and second array of alignment features F1, F2 are complementary to each other. As shown in FIG. 2A, the first array of alignment features F1 comprises a first interstitial two-dimensional planar array of protrusions (or bumps) P1 defining a first array of interstices I1, and the second array of alignment features F2 comprises a second interstitial two-dimensional planar array of protrusions P2 defining a second array of interstices I2. Each of the first and second arrays of protrusions P1, P2 defines an array of discrete protrusions separated and isolated from one another on the respective first and second surfaces S1, S2. Each protrusion of the first and second arrays of protrusions P1, P2 comprises a convex side wall W about a vertical axis orthogonal to the corresponding first and second surfaces S1, S2. In the illustrated embodiment, the side wall W of each protrusion P1, P2 of the first and second array of protrusions is axially symmetrical about a vertical axis orthogonal to the corresponding surfaces S1, S2 and has convex slope in the axial plane (the vertical plane containing the vertical axis).

FIG. 2C to 2E illustrate the first body/base B1 is being pressed/mated against the second body/B2 with the first and second arrays of alignment features F1, F2 mating towards each other. The first and second arrays of protrusions P1, P2 intermesh, with the protrusions defined on one of the first and second bodies received in corresponding interstices I1, I2 defined on the other one of the first and second bodies. Specifically, referring to FIG. 2C which illustrates the coupled state of the connector to the foundation, each of the protrusions P1 is received in the interstices I2 defined in the space between three protrusions P2, and each of the central protrusions P2 is received in the interstices I1 defined in the space between three protrusions P1. In this embodiment, the protrusions P2 at the perimeter or outer regions of the second array of protrusions are not received in interstices I1. Each interstice I1, I2 has a bottom corresponding to the corresponding planar surfaces S1, S2.

Given the convex side wall W of the protrusion surfaces of each adjacent pair of protrusions P1 and P2 are in point contact Cp against each other. At least at such point contact Cp between the protrusion surfaces of adjacent pair of protrusions P1 and P2, the contacting side wall each has a convex radius of curvature with respect to the vertical axis and has a convex slope along the contacting side wall in an axial plane including the axis (orthogonal to the corresponding first and second surfaces). In one embodiment, the side wall W of each protrusion P1, P2 has a protrusions surface having a geometry that substantially conforms to the surface of a hemisphere or a truncated part thereof (e.g., a sectional slice of a hemisphere through its vertical axis with a truncated top and/or bottom). Alternatively, the protrusions can take on a truncated conical geometry having convex sloping walls.

Specifically, referring to FIG. 2C, each of the protrusions P1 has three points of contact Cp in three adjacent pairs of protrusions P1 and P2. On the other hand, other than the two protrusion P2 at the center region of S2 in the second array having three points of contact Cp, the protrusions P2 at the perimeter or outer regions of the second array has less than three points of contact.

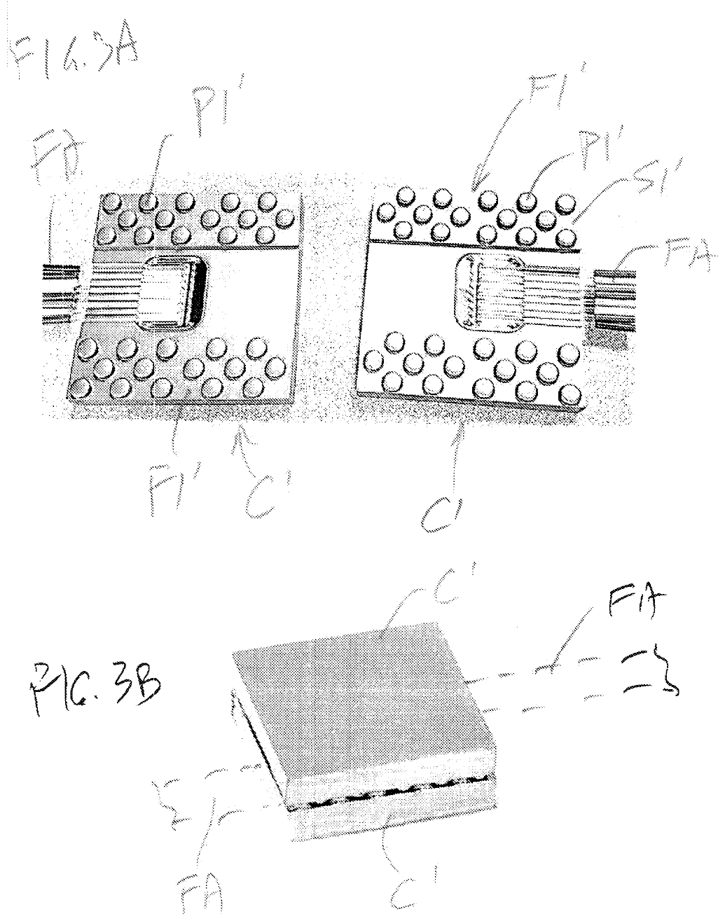

As shown in FIGS. 2A and 2B, the first and second planar arrays of protrusions each comprises a cluster of protrusions P1, P2 spatially distributed on the respective first and second surfaces S1, S2 in a symmetrical pattern with respect to at least one axis in the plane of the respective first and second surfaces S1, S2. (See also FIG. 3A, which shows an embodiment in which symmetry of each cluster of protrusions on a surface is about only one axis, although there is open span symmetry of two cluster of protrusions about the median of the connector C′ (about the axis of the optical bench supporting the fiber array FA in FIG. 3). As shown, each array is symmetrical with respect to two orthogonal axes in the plane of the respective surfaces S1, S2. In the illustrated embodiment, all the protrusions P1, P2 are similar in size and geometry. However, the size and/or geometry of the protrusions of one array may be of different from that of the protrusions in the other array. Furthermore, it is conceivable that the protrusions within the same array may be of different sizes and/or geometries, without departing from convex protrusion surfaces contacting at point contact Cp between adjacent pairs of protrusions P1 and P2.

As shown in the embodiment of FIG. 2E, each protrusion P1, P2 has an apex A that may also contact the corresponding first and second planar surfaces at a point (by the truncated top shown in 2E) when the first body/base B1 is pressed against the second body/base B2 with the first and second arrays of alignment features F1, F2 towards each other.

Accordingly, in the embodiment of FIG. 2, the first body/base B1 is removably attachable to the second body/base B2 to define a demountable coupling, with the first array of alignment features against the second array of alignment features F1, F2 to define an elastic averaging coupling, thereby passively aligning the first body to the second body.

In one embodiment, each of the first and second arrays of protrusions defines an array of discrete protrusions separated and isolated from one another on the respective first and second surfaces. In one embodiment, each protrusion of the first and second arrays of protrusions comprises a side wall about an axis orthogonal to the corresponding first and second surfaces, wherein at least at the point contact between the protrusion surfaces of adjacent pair of protrusions, the side wall has a convex radius of curvature with respect to the axis and has a convex slope along the side wall in an axial plane including the axis (orthogonal to the corresponding first and second surfaces).

It is understood that alternatively, the alignment features F1, F2 (i.e., the first and second arrays of protrusions P1, P2) disclosed in the above embodiments may be swapped between the interfacing surfaces of the bodies/bases B1, B2 of the optical connector C and the foundation F, without departing from the scope and spirit of the present invention.

Various potential benefits can be achieved by the inventive elastic averaging coupling features, including improved coupling/alignment accuracy by averaging of alignment errors, stiffer than exact constraint alignment (e.g. kinematic coupling), or using an alignment pin and alignment hole, higher load capacity (due to multiple contact points), nearly as repeatable as exact constraint alignment, multiple detachable cycles, elastic deformation confined to compliant structures, and improved structural dynamics if the protrusions are not too compliant (shorter unsupported spans and more damping).

In one embodiment, the first base B1 comprises a first malleable metal material and the first array of alignment features F1 of the optical connector C are integrally defined on the first base by stamping the malleable metal material, and the second base B2 comprises a second malleable material (which may be same as the first malleable material) and the second array of alignment features F2 of the foundation are integrally defined on the base by stamping the second malleable metal material. In one embodiment, the first array of mirrors M1 and the first array of alignment features F1 are simultaneously defined on the first base by stamping a first body of metal blank and the second array of mirrors M2 and the second array of alignment features F2 are simultaneously defined on the second base by stamping a second body of metal blank. By high-precision stamping to integrally/simultaneously form the passive alignment features and/or the micro optical bench (MOB) on the foundation and the optical connector, the components can be produced economically in high or small volumes, while improving tolerance, manufacturability, ease of use, functionality and reliability. The foundation and/or optical bench components should be made of a stampable materials like ductile metals such as Kovar, Invar, stainless steel, aluminum. Preferably, the optical bench and foundation should both have similar coefficients of thermal expansion (CTEs), so that misalignment does not occur during temperature cycles and stress/strains are not generated.

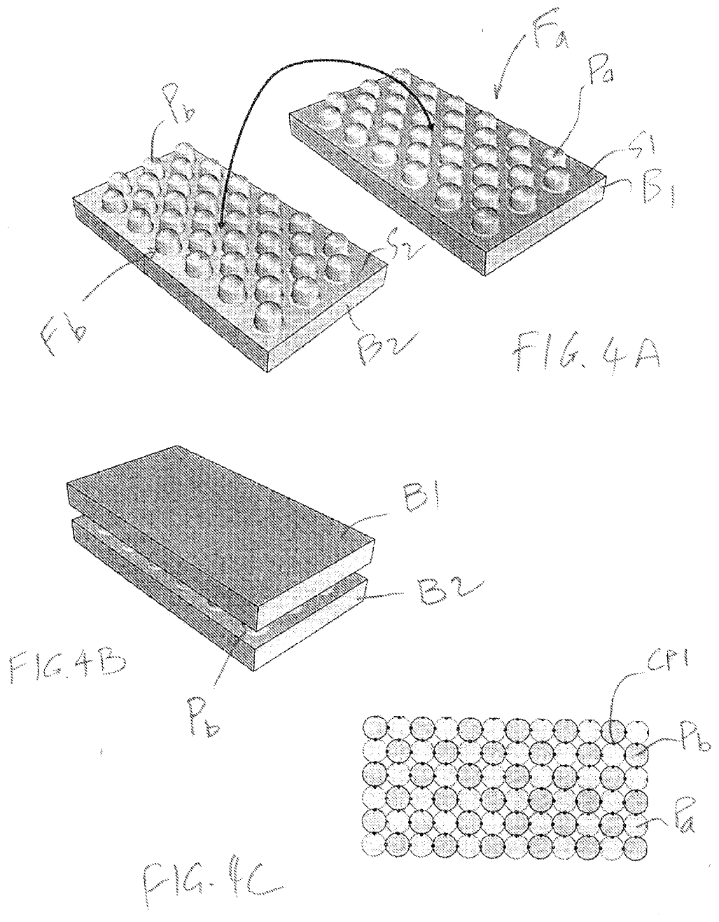

FIGS. 3A and 3B illustrate passive alignment features of an optical connector C′ and a foundation in the form of another optical connector C′, in accordance with another embodiment of the present invention. FIG. 3A is a plan view of the interfacing surfaces S1′ of the two optical connectors C′ that each comprises similar alignment features F1′. As illustrated, the ‘foundation’ comprises another optical connector C′ of similar structure, whereby the two optical connectors C′ may be optically coupled to communicate optical signals. In other words, the external component having the foundation to be optically coupled to by the optical connector module C′ is simply another similarly structured (or otherwise optically and mechanically compatible) optical connector module C′. FIG. 3B is a perspective view of the optical connectors C′ shown in FIG. 3A optically coupled together (the fiber array FA shown in dotted lines). In this embodiment, the protrusions P1′ are shown to have a different geometry from the previous embodiment in FIG. 2, but a similar geometry closer to the embodiment of FIG. 4, which will be explained further below.

FIG. 4 illustrates another embodiment of protrusions that can replace the protrusions in FIG. 2 for elastic averaging alignment coupling. For the ease of explanation of this embodiment, instead of referring to connector and foundation, first body B1 and second body B2 will be referred to, with the understanding the first body B1 may be an integral part of or attached to an optical connector C, and the second B2 may be an integral part of or attached to a foundation F, or an integral part of or attached to an external component such as an optoelectronic device (e.g., PIC), or as another optical connector.

FIG. 4A schematically illustrates complementary elastic averaging alignment features Fa, Fb (comprising complementary first and second arrays of protrusions Pa, Pb) at opposing mating surfaces S1, S2 of the first and second bodies B1 and B2, in accordance with one embodiment of the present invention. As was in the previous, the inventive passive alignment coupling in this embodiment comprises a first body defining a first base B1 having a first, planar, surface S1 (i.e., a first mating or interfacing surface) on which a first array of alignment features Fa is defined; and a second body providing an alignment reference to the first body, wherein the second body defines a second base B2 (comprising two separate bases in the illustrated embodiment in FIG. 2) having a second, planar, surface (i.e., a second mating or interfacing surface) on which a second array of alignment features Fb is defined. The first and second array of alignment features Fa, Fb are complementary to each other. As shown in FIG. 4A, the first array of alignment features Fa comprises a first interstitial two-dimensional planar array of protrusions (or bumps) Pa defining a first array of interstices Ia, and the second array of alignment features Fb comprises a second interstitial two-dimensional planar array of protrusions Pb defining a second array of interstices Ib. Each of the first and second arrays of protrusions Pa, Pb defines an array of discrete protrusions separated and isolated from one another on the respective first and second surfaces S1, S2. In this embodiment, the first and second arrays of protrusions Pa, Pb comprise protrusions spatially distributed on the respective first and second surfaces S1, S2 in a similar pattern.

FIG. 4B illustrates a perspective view of demountable coupling between the body B1 (e.g., a connector) and body B2 (e.g., a “foundation”) in FIG. 4A with the first and second arrays of alignment features Fa, Fb mating towards each other. The first and second arrays of protrusions Pa, Pb intermesh, with the protrusions defined on one of the first and second bodies received in corresponding interstices Ia, Ib defined on the other one of the first and second bodies. Similar to the previous embodiment of FIG. 2 (with the exception of number of contact points between adjacent pair of protrusions), and referring also to FIG. 4C, each of the inner protrusions Pa is received in the interstices Ib defined in the space between four protrusions Pb, and each of the inner protrusions Pb is received in the interstices Ia defined in the space between four protrusions Pa. In this embodiment, the respective protrusions Pa, Pb at the perimeter or outer regions of the respective first and second arrays of protrusions are not received in corresponding interstices Ia, lb. Each interstice Ia, Ib has a bottom corresponding to the corresponding planar surfaces S1, S2.

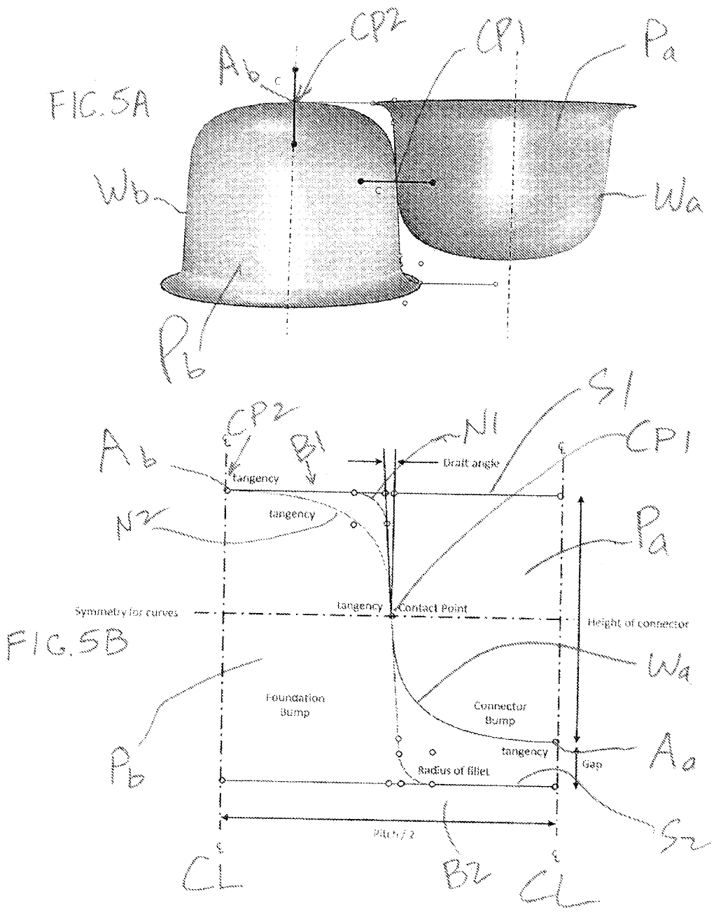

FIG. 4C schematically illustrates the contact points between complementary arrays of protrusions Pa, Pb, in accordance with one embodiment of the present invention. Referring also to FIGS. 5A and 5B, FIG. 5A is a schematic perspective view illustrating contacts between complementary bumps in the complementary arrays of elastic averaging alignment features, in accordance with one embodiment of the present invention; and FIG. 5B is a schematic graphical view illustrating contacts between complementary protrusions (also referred to as “Bumps” in FIG. 5) in the complementary arrays of elastic averaging alignment features, in accordance with one embodiment of the present invention. For this elastic averaging alignment coupling, constraints are also established by point contacts. FIG. 5A is a schematic perspective view illustrating contacts between complementary protrusion Pa and Pb in the complementary arrays of elastic averaging features. FIG. 5B is a schematic graphical view illustrating contacts between complementary protrusions Pa and Pb in the complementary arrays of elastic averaging features. Referring to FIG. 5B the single contact point CP1 between each pair of protrusions Pa and Pb are due to the convex radii of curvature on both bodies B1, B2 and the draft slope on side walls of adjacent pair of protrusions.

Each protrusion Pa, Pb of the first and second arrays of protrusions comprises respective convex side wall Wa, Wb about a vertical axis orthogonal to the corresponding first and second surfaces S1, S2. In the illustrated embodiment, the side wall Wa, Wb of each protrusion Pa, Pb of the first and second array of protrusions is axially symmetrical about a vertical axis orthogonal to the corresponding surfaces S1, S2 and has convex slope in the axial plane (the vertical plane containing the vertical axis), at least at the point contact CP1 between the convex protrusion surfaces/walls Wa and Wb of adjacent pair of protrusions Pa and Pb. At the contact point CP1, the side wall has a convex radius of curvature with respect to the vertical axis (or centerline CL) and has a convex slope along the side wall in an axial plane including the axis (orthogonal to the corresponding first and second surfaces). Specifically in this embodiment, the side walls Wa, Wb of each protrusion Pa, Pb is axially symmetrical about the axis CL and has a draft slope at a draft angle to the axis CL, wherein the respective side walls Wa and Wb defines a single point of contact CP1 between the protrusion surfaces of each adjacent pair of protrusions Pa and Pb.

Each of the protrusions Pa in the inner part of the first array has four points of contact CP1 in four adjacent pairs of protrusions Pa and Pb, and each of protrusions Pb at inner part of S2 in the second array have four points of contact CP1. As shown in FIG. 4C, the protrusions Pa, Pb at the perimeter or outer regions of the respective first and second arrays has three points of contact CP1 (for the protrusions along the sides of the respective array) or two points of contact (for the protrusions at the corners of the respective array).

In a specific embodiment, the side wall Wa, Wb of each protrusion Pa, Pb is shaped to follow or conform to a surface of a body generated by rotating a non-uniform rational b-spline (NURBS) curve about the axis, and wherein the point contact is located at the symmetry line for the NURBS curves of each adjacent pair of protrusions, whereby tangency is present at the point contact to define the single point of contact between the protrusion surfaces of each adjacent pair of protrusions. Referring to FIG. 5B, the protrusions Pa and Pb are constructed by revolving non uniform rational b-spline (NURBS) curves N1 and N2 around two corresponding axes, as further schematically illustrated in FIG. 5B. The parametric geometry defining convex protrusions Pa and Pb include the following characteristics:
a. Convex bumps Pa and Pb are parametrically defined using NURBS curves N1 and N2
b. The curves N1 are revolved about right centerline to construct protrusions Pa on the body B1
c. The curves N2 are revolved about left centerline to construct protrusions Pb on the body B2
d. Contact CP1 is made at symmetry line for the curves N1 and N2.
e. Tangency is present at each contact point

There is a further point contact CP2 at the apex Ab of lower protrusions Pb at the B2 (e.g., foundation) side, against the planar surface S1 of the body B1. In this embodiment, each protrusion Pb of the second array of protrusions is taller than each protrusion Pa of the first array of protrusion, wherein each protrusion Pb of the second array of protrusions has a convex apex Ab, wherein when the first body B1 is pressed/preloaded against the second body B2 with the first and second arrays of alignment features towards each other, the apex Ab of each of the taller protrusions of the second array of protrusions Pb contacts the first planar surface S1 of the first body at a point contact at the interstices Ia (i.e., bottom or base plane of the interstices) defined by the first array of protrusions Pa, wherein a gap remains between the top of each protrusion of the first array of protrusions and the second planar surface at the interstices defined by the second array of protrusions. The apex Aa of the upper protrusion Pa at the B1 (e.g., connector) side does not contact the planar surface S2 of body B2, with a gap between the apex Aa of the upper protrusion Pa and the surface S2 of body B2.

It is understood that alternatively, the alignment features Fa, Fb (i.e., the first and second arrays of protrusions Pa, Pb) disclosed in the above embodiments may be swapped between the interfacing surfaces of the bodies/bases B1, B2 of the first and second bodies (e.g., an optical connector and a foundation), without departing from the scope and spirit of the present invention.

Accordingly, in the embodiment of FIG. 4, the first body/base B1 is removably attachable to the second body/base B2 to define a demountable coupling, with the first array of alignment features against the second array of alignment features Fa, Fb to define an elastic averaging coupling, thereby passively aligning the first body to the second body.

As was in the previous embodiment, the first base B1 may comprises a first malleable metal material and the first array of alignment features Fa of the first body/base B1 are integrally defined on the first base by stamping the malleable metal material, and the second base B2 may comprises a second malleable material (which may be same as the first malleable material) and the second array of alignment features Fb are integrally defined on the base by stamping the second malleable metal material. Alternatively, the first and second arrays of protrusions Pa, Pb are integrally formed on the corresponding first and second bodies B1, B2, e.g., by etching silicon or glass substrate). Preferably, both the base B1, B2 should have similar coefficients of thermal expansion (CTEs), so that misalignment does not occur during temperature cycles and stress/strains are not generated. Other design considerations in the earlier embodiment can also apply to this embodiment.

Various potential benefits can be achieved by the inventive embodiments of elastic averaging alignment coupling features disclosed above, including improved coupling/alignment accuracy by averaging of alignment errors, stiffer than exact constraint alignment (e.g., using an alignment pin and alignment hole), higher load capacity (due to multiple contact points), nearly as repeatable as exact constraint alignment, multiple detachable cycles, elastic deformation confined to compliant structures, and improved structural dynamics if the protrusions are not too compliant (shorter unsupported spans and more damping).

In both embodiments depicted in FIGS. 2 and 4, the number of protrusions are shown only for purposes of illustration. In one embodiment, each of the first and second arrays of protrusions includes at least 10 to 100 discrete protrusions for a coupling interface between the first body and the second body having a planar area of about 10 mm² to 50 mm², so as to achieve a coupling accuracy of less than 1 micrometer between the first body and the second body. In a further embodiment, each of the first and second arrays of protrusions is a rectangular staggered array of M×N discrete protrusions. In one embodiment, M is preferably in a range of 3 to 10 and N is preferably in a similar range of 3 to 10 for a coupling interface between the first body and the second body having a planar area of about 5 mm²×50 mm², so as to achieve a coupling accuracy of less than 1 micrometer between the first body and the second body.

FIGS. 6-9 illustrate perspective side views of the demountable couplings between respective first body/base B1 (e.g., an optical connector C) having the inventive elastic averaging protrusions Pa, Pb as described above and a second body/base B2 (e.g., a foundation) in various planar distribution, and schematic graphical views illustrating the planar distributions of the protrusions Pa, Pb and the contact points between complementary arrays of protrusions with exemplary relative dimensions in accordance with various embodiments of the present invention.

FIG. 6A shows the same bodies B1 and B2 as the embodiment illustrated in FIG. 4A. FIG. 6B illustrates the open span distribution of protrusions P1 and P2 in the x-direction upon coupling engagement.

FIGS. 7A and 7B show the bodies B1 and B2 with a different open span distribution of protrusions P1 and P2 in the x-direction. FIG. 7B illustrates the open span distribution of protrusions P1 and P2 in the x-direction upon coupling engagement.

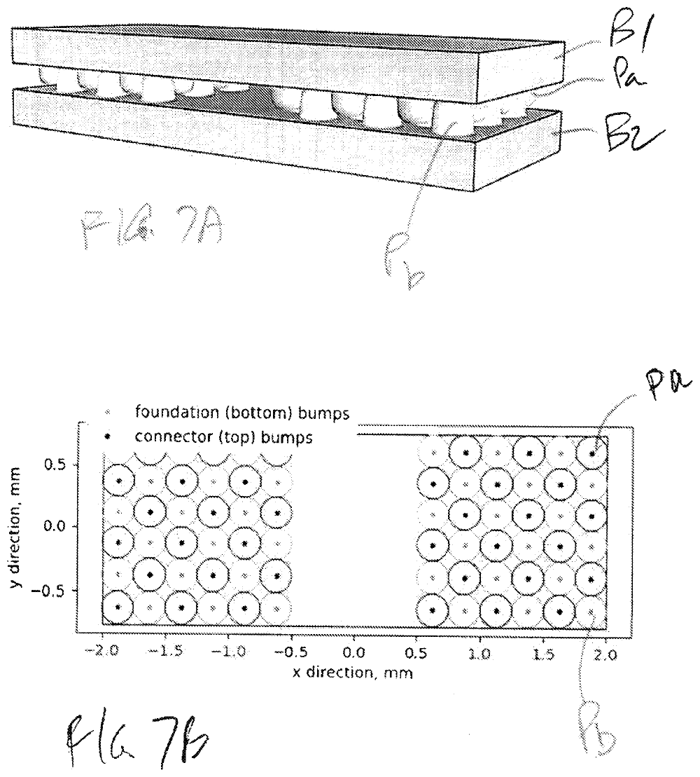

FIGS. 8A and 8B show the bodies B1 and B2 with a further different open span distribution of protrusions P1 and P2 in the x-direction. FIG. 8B illustrates the open span distribution of protrusions P1 and P2 in the x-direction upon coupling engagement. In this embodiment, there is symmetry about the x=0 direction.

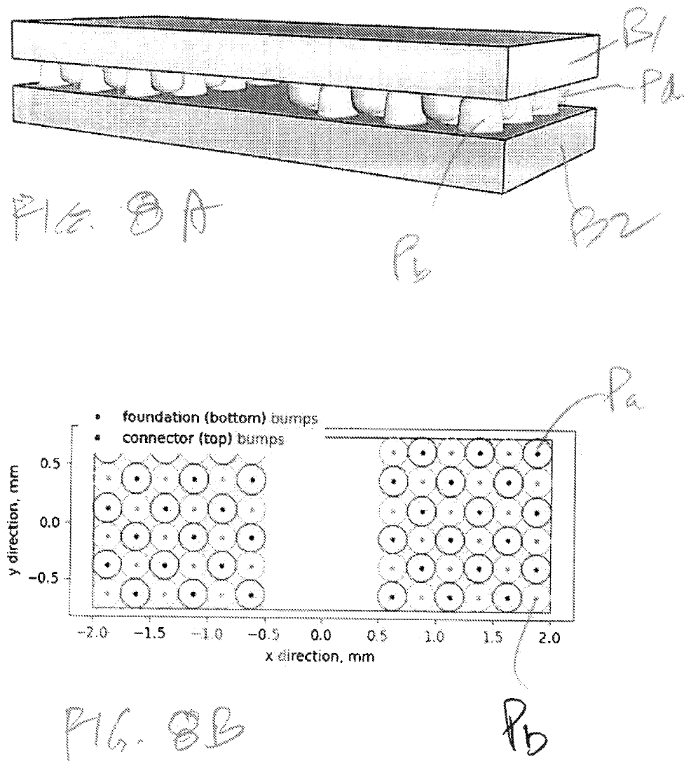

FIGS. 9A and 9B show the bodies B1 and B2 with a still further different open span distribution of protrusions P1 and P2 in the x-direction. FIG. 9B illustrates the open span distribution of protrusions P1 and P2 in the x-direction upon coupling engagement. In this embodiment, there is symmetry about both the x=0 direction and y=0 direction.

As shown in FIGS. 2A and 2B, the first and second planar arrays of protrusions each comprises a cluster of protrusions P1, P2 spatially distributed on the respective first and second surfaces S1, S2 in a symmetrical pattern with respect to at least one axis in the plane of the respective first and second surfaces S1, S2. (See also FIG. 3A, which shows an embodiment in which symmetry of each cluster of protrusions on a surface is about only one axis, although there is open span symmetry of two cluster of protrusions about the median of the connector C′ (about the axis of the optical bench supporting the fiber array FA in FIG. 3). As shown, each array is symmetrical with respect to two orthogonal axes in the plane of the respective surfaces S1, S2. In the illustrated embodiment, all the protrusions P1, P2 are similar in size and geometry. However, the size and/or geometry of the protrusions of one array may be of different from that of the protrusions in the other array. Furthermore, it is conceivable that the protrusions within the same array may be of different sizes and/or geometries, without departing from convex protrusion surfaces contacting at point contact Cp between adjacent pairs of protrusions P1 and P2.

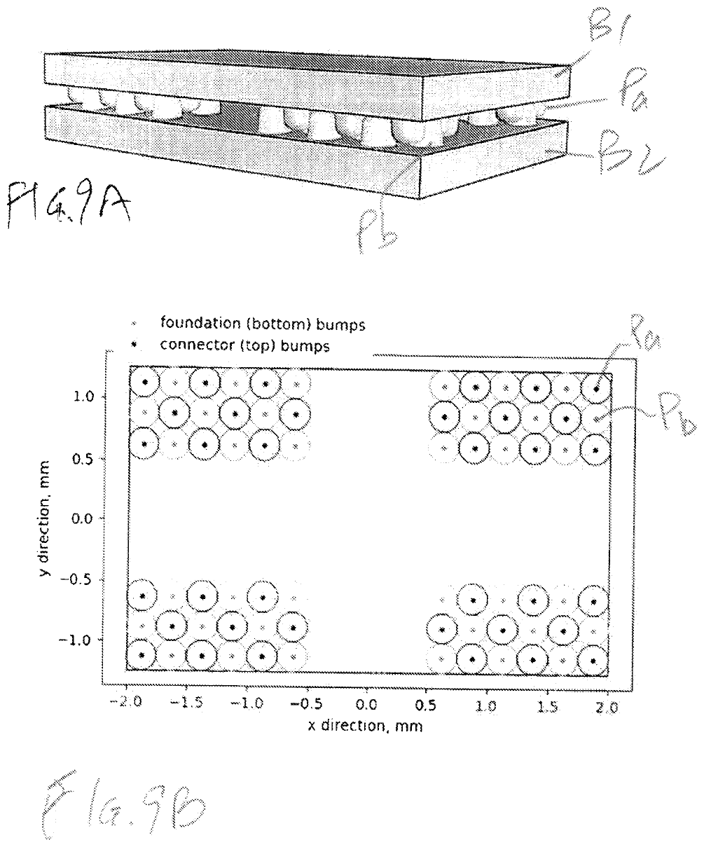

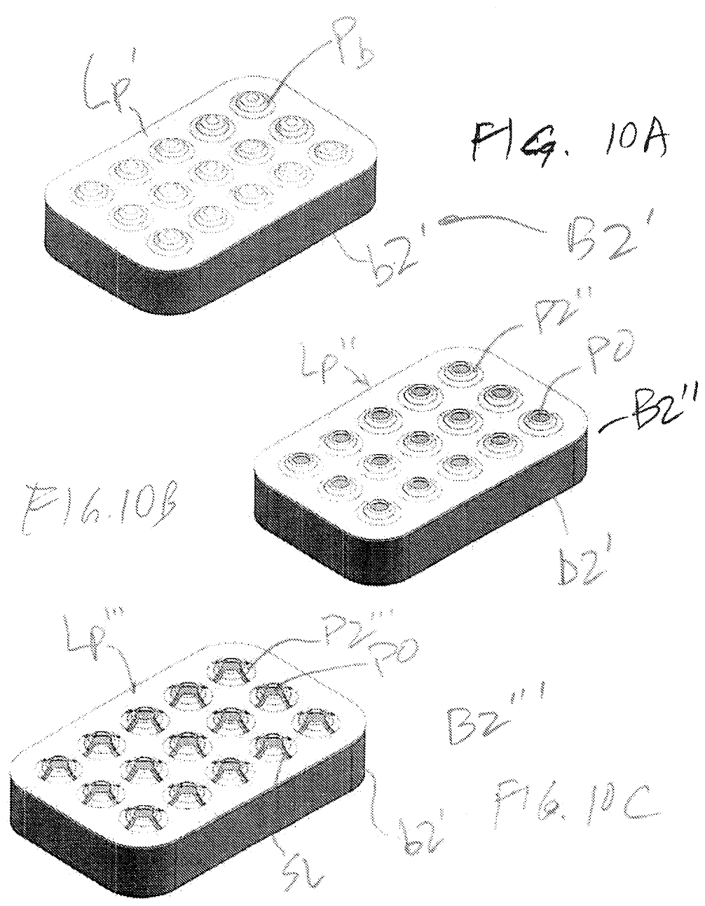

FIG. 10A to 10C illustrate further embodiments of protrusion arrays of elastic averaging coupling interfaces. Instead of the first and second arrays of protrusion integrally forming on the corresponding first and second bodies (e.g., by etching or stamping a metal, silicon or glass substrate), FIG. 10A schematically illustrates a second body B2′ comprising a first base b2′ and a separate layer Lp′ of an array of protrusions P2 defined on surface S2 (e.g., form by etching or stamping a sheet of metal, etching a silicon or glass substrate). The layer Lp′ is attached to the top of base b2′. In FIG. 10B, a separate layer Lp″ of array of protrusions P2″ may be further formed with an opening PO at the apex of each protrusion P2″. The layer Lp″ is attached to the top of a base b2′ to form a second body B2″. In FIG. 10C, a separate layer Lp′″ may be further formed with an array of protrusions P2′″ with an opening PO at the apex of each protrusion along with slits SL along the side wall of each protrusion, thereby providing a more flexible, pliant or compliant structure. The layer Lp′″ is attached to the top of a base b2′ to form a second body B2′″.

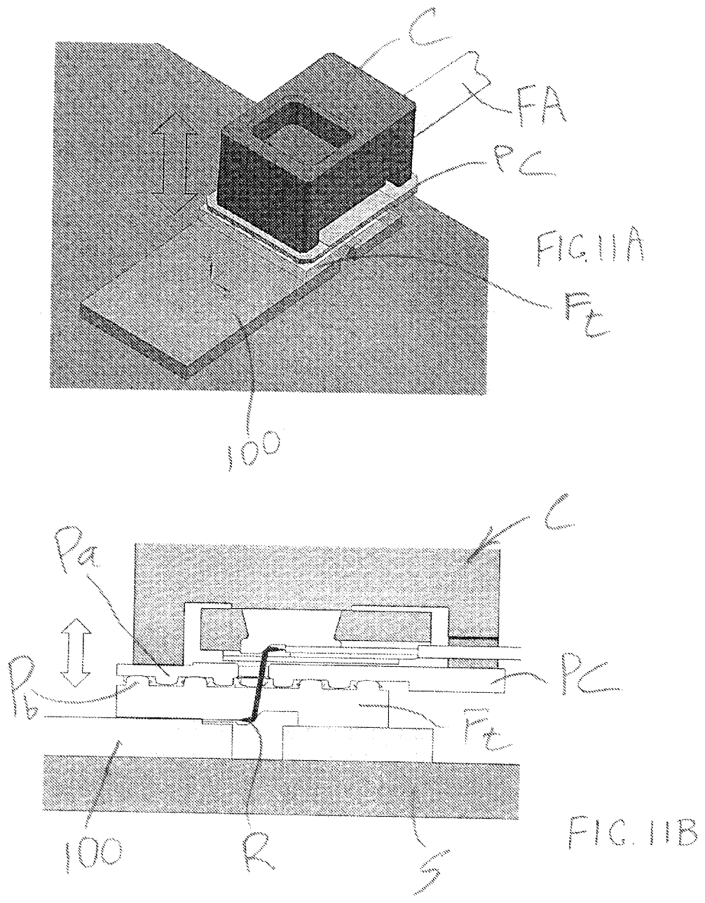

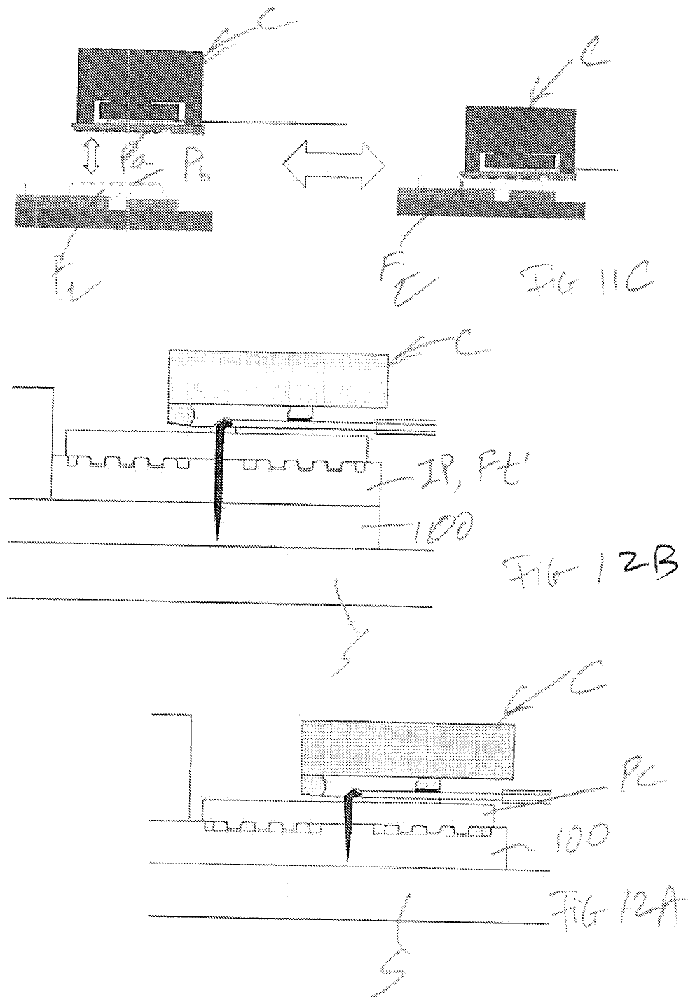

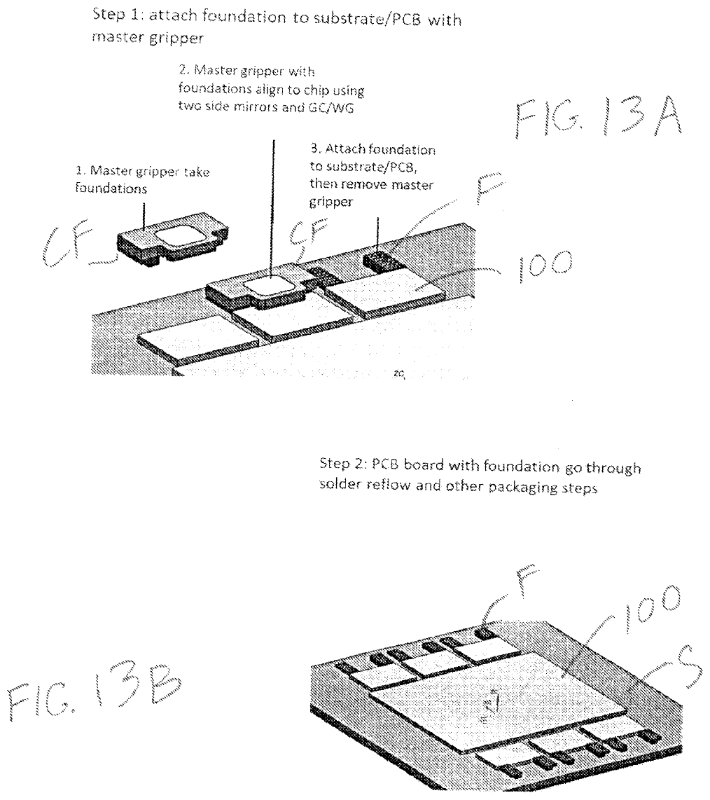

FIGS. 11 and 12 illustrate further embodiments of demountable coupling of connectors and foundations that can implement the elastic averaging alignment features of the present invention. FIGS. 11A to 11C illustrate implementation of an optically transparent foundation Ft having an integral internally reflective surface R as an edge coupler to a PIC chip package 100. The foundation Ft has an array of protrusions Pb (as described above). The foundation Ft is supported to the edge of the PIC 100, directing light signal to and from the PIC 100 via the reflective surface R. An optically transparent cover plate PC having an array of protrusions Pa (as described above) for elastic averaging alignment coupling is attached to be part of the connector C. Demountable coupling of the optical connector C to the PIC chip package 100 is between the cover plate PC as the “first body B1” discussed above and the foundation Ft. Further structural details of this embodiment beyond that of the elastic averaging alignment features discussed herein can be referred in PCT Application No. PCT/US2023/070007 filed on Jul. 11, 2023, now published as WO/______, which is commonly assigned to the assignee of the present application, and fully incorporated by reference herein.

FIG. 12A is a sectional view of an embodiment of a demountable coupling of an optical connector C directly to the top a PIC chip package 100. No transparent foundation is used in this embodiment. The PIC chip package is provided with an array of protrusions Pb (as described above). An optically transparent cover plate PC having an array of protrusions Pa (as described above) for elastic averaging alignment coupling is attached to be part of the connector C. Demountable coupling of the optical connector C to the PIC chip package 100 is between the cover plate PC as the “first body B1” discussed above and the PIC package 100 as the “second body B2” in this embodiment. Further structural details of this embodiment beyond that of the elastic averaging alignment features discussed herein can be referred in PCT Application No. PCT/US2023/074220 filed on Sep. 14, 2023, now published as WO/______, which is commonly assigned to the assignee of the present application, and fully incorporated by reference herein.

FIG. 12B is a sectional view of another embodiment of a demountable coupling of an optical connector C to a PIC chip package C via a transparent interposer IP as a foundation Ft′ attached to the top of the PIC 100. Similar to the previous embodiments of FIG. 11, the transparent foundation Ft′ has an array of protrusions Pb (as described above). The foundation Ft′ is supported to the top of the PIC 100. An optically transparent cover plate PC having an array of protrusions Pa (as described above) for elastic averaging alignment coupling is attached to be part of the connector C. Demountable coupling of the optical connector C to the PIC chip package 100 is between the cover plate PC as the “first body B1” discussed above and the interposer/foundation Ft′ as the “second body B2” in this embodiment. Further structural details of this embodiment beyond that of the elastic averaging alignment features discussed herein can be referred in PCT Application No. PCT/US2023/074220 filed on Sep. 14, 2023, now published as WO/______, which is commonly assigned to the assignee of the present application, and fully incorporated by reference herein.

FIGS. 13A to 13C illustrate a process of securing position of the foundations F for subsequent demountable connection of optical connectors C, in accordance with one embodiment of the present invention. The optical connector C may be embodied as a termination of a fiber array FA of a jumper shown in FIG. 13D.

An assembly optical connector is provided as a master optical connector form CF for assembly of the foundations F. FIG. 14B illustrates an embodiment of a master optical connector form CF. The master optical connector form CF conforms to the passive alignment features F1 and the optical inputs/outputs corresponding to the optical connector C that is designed or designated to be mechanically and optically coupled to the external optoelectronic device 100. The master optical connector form CF is first demountably coupled to the foundation F, as shown in FIG. 14C. FIG. 14A schematically illustrates the grating couplers GC1, GC2 and waveguide WG on a PIC device 100 for loop-back active alignment of a master optical connector form CF or to a support S (e.g., PCB, submount and/or interposer), the PIC device 100, in accordance with one embodiment of the present invention. The master optical connector form CF is actively aligned to the optoelectronic device 100 by positioning the foundation F relative to the optoelectronic device 100 (e.g., a PIC chip or an optical I/O chip) to obtain an optimum optical signal between the optoelectronic device 100 and the master optical connector form CF (e.g., via optical signals via optical fibers supported by the optical connector form CF). The location of the foundation F is secured with respect to the optoelectronic device 100 at the aligned position (e.g., using a solder to tack the position of the foundation on the support S for the optoelectronic device, such as an interposer, a printed circuit board, a submount, etc.). The master optical connector form CF is then demounted from the foundation F that is locked in position relative to optoelectronic device 100. The foundation can then be permanently attached to the support S (e.g., solder reflowing) without changing its position of the foundation F on the support surface S of the optoelectronic device. Thereafter, the designated optical connector C (having the elastic averaging alignment features described above) can be repeatedly connected and disconnected and reconnected to the foundation F non-destructively without losing the original optical alignment obtained by active alignment between the optical connector form CF and the optoelectronic device 100. Optical alignment in accordance with original active alignment is maintained for each connect and disconnect and reconnect, to align the optical connector C precisely and accurately to the foundation F.

While the invention has been particularly shown and described with reference to the preferred embodiments, it will be understood by those skilled in the art that various changes in form and detail may be made without departing from the spirit, scope, and teaching of the invention. Accordingly, the disclosed invention is to be considered merely as illustrative and limited in scope only as specified in the appended claims.

We claim:

1. A passive alignment coupling, comprising:
a first body defining a first base having a first, planar, surface on which a first array of alignment features is defined,
a second body providing an alignment reference to the first body, wherein the second body defines a second base having a second, planar, surface on which a second array of alignment features is defined, wherein the first and second array of alignment features are complementary to each other;
wherein one of the first array of alignment features and the second array of alignment features comprises a first interstitial two-dimensional planar array of protrusions defining a first array of interstices, and another one of the first array of alignment features and the second array of alignment features comprises a second interstitial two-dimensional planar array of protrusions defining a second array of interstices,
wherein with the first body pressed against the second body with the first and second arrays of alignment features mating towards each other, the first and second arrays of protrusions intermesh with the protrusions defined on one of the first and second bodies received in corresponding interstices defined on the other one of the first and second bodies, and
wherein protrusion surfaces of each adjacent pair of protrusions of the first and second arrays of protrusions are in point contact,
whereby the first body is removably attachable to the second body to define a demountable coupling, with the first array of alignment features against the second array of alignment features to define an elastic averaging coupling, thereby passively aligning the first body to the second body.
